(19) United States
(12) Patent Application Publication
(10) Pub. No.: US 2010/0037285 A1
(43) Pub. Date: Feb. 11, 2010

(54) USER-CRITERIA BASED PRINT JOB SUBMISSION APPROVAL POLICY IN A PRINT SHOP MANAGEMENT SYSTEM

(75) Inventor: Shane Matthew Cain, Carlsbad, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/186,679

(22) Filed: Aug. 6, 2008

(51) Int. Cl. G06F 17/00; G06F 3/12

(52) U.S. Cl. 726/1; 358/1.15

(57) ABSTRACT

In a print shop management system, a print job submission approval policy is provided to determine whether a print job submission made by a particular user is approved or prohibited. The policy includes multiple policy settings of job restriction criteria enforced at job submission time. The restrictions may be based on job price, certain restricted functions, resource usage, etc. If the job submission is prohibited, a message is displayed to the user but the print job is not submitted to the printer. Each policy setting may be applied to a user based on his user role or user name. Each policy setting is created by an administrator. A user interface for inputting policy setting values is disclosed.

### BACKGROUND OF THE INVENTION

1. Field of the Invention

This invention relates to print job processing method and apparatus, and more particularly, it relates to print job processing method and apparatus for a print shop employing multiple printers and finishing devices.

2. Description of Related Art

In an environment that processes a large number of print jobs with multiple printers, there has been a need to manage print jobs efficiently in an organized fashion. Examples of such an environment are professional print shops and print/copy departments at large organizations, where a variety of print requests, such as large-volume duplication and large document printing, needs to be processed and completed by utilizing multiple printers within a short turn-around time. These environments are collectively referred to as “print shops” in this application. Typically, each printing job specifies a source file that electrically contains a document to be printed, the size, color and the type of the paper on which the document should be printed, the printing resolution, duplex or single-side printing, and certain finishing conditions, such as book, staple, collate printing, etc., depending on a print job requester's needs. In order to process a large volume of print jobs that each differ in terms of these job parameters, a print shop utilizes multiple commercial grade printers, including black & white and color printers. Each of these printers has limitations on available printer settings, such as the paper size, the paper type, resolution settings, etc. In addition, the print shop employs various finishing devices, such as collators, staplers, hole punchers, folding machines, binding machines, etc. A print shop management system is typically implemented on a print shop management apparatus such as a control computer connected to the printers to submit (i.e. assign) each print job to one or more printers and finishing devices to produce the print job. The job submission may be done automatically by the print shop management system, semi-automatically with certain amount of operator intervention, or manually where decisions of how to submit the print jot to appropriate printers or finishing devices are made by an operator.

### SUMMARY

Under certain circumstances, a print shop manager or owner may desire a more granular control over the ability of employees to submit jobs to printing devices (printers).

Accordingly, the present invention provides a print shop management system that allows a system administrator to establish multiple sets of criteria to restrict print job submission to printers based on print job settings, experience of the employee making the submission, available printer resources, etc.

An object of the present invention is to provide a print shop management system that helps to reduce production mistakes (such as the need to “reprint” jobs), physical resource waste, printer resource drainage from “resource intensive” jobs, etc., due to inexperience of employees.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for processing a print job submission implemented in a print shop management apparatus which manages a plurality of printers, which includes: (a) storing a print job submission approval policy in the print shop management apparatus, the print job submission approval policy including a plurality of policy settings, each policy setting defining one or more job restriction criteria, each policy setting further defining one or more user criteria to specify which users the policy setting is applicable to; (b) when a user requests to submit a print job to a printer, determining whether any policy setting is applicable to the user based on the user criteria for each policy setting; (c) if one or more policy settings are applicable to the user, determining whether the submission is approved by comparing the job restriction criteria of the applicable policy settings with corresponding settings of the print job being submitted; (d) if the submission is not approved, refraining from submitting the print job to the printer; and (e) if no policy setting is applicable to the user or if the submission is approved, submitting the print job to the printer for printing. The user criteria may include a user role or a user name or both.

In another aspect, the present invention provides a method for processing a print job submission implemented in a print shop management apparatus which manages a plurality of printers, which includes: (a) receiving a request to submit a print job to a printer; (b) estimating an amount of a resource required for the print job based on settings of the print job; (c) determining an amount of the resource available on the printer at submission time; (d) if the required amount of the resource exceeds the available amount of the resource, refraining from submitting the print job to the printer; and (e) if the required amount of the resource does not exceed the available amount of the resource, submitting the print job to the printer for printing.

In another aspect, the present invention provides a computer program product that causes a print shop management apparatus to perform the above methods.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a process of print job submission approval policy creation and policy enforcement at submission time according to an embodiment of the present invention.

FIGS. 2A and 2B illustrate a user interface used to create a print job submission approval policy according to an embodiment of the present invention.

FIG. 3 shows a print shop system according to an embodiment of the present invention.

### DETAILED DESCRIPTION OF PREFERRED EMBODIMENTS

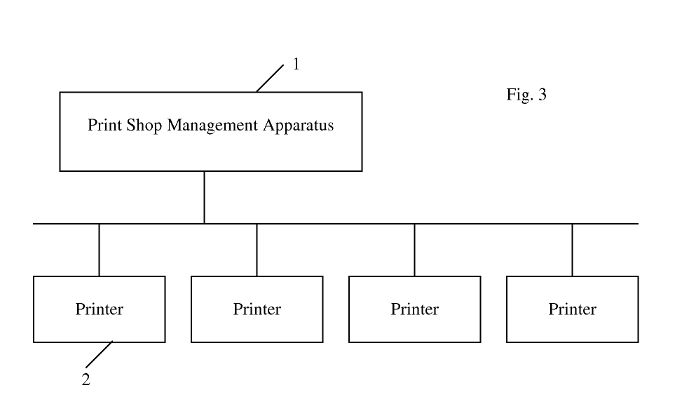

Embodiments of the present invention provide a print job submission approval policy (referred to as “submission policy” for convenience) to determine whether a print job submission requested by a particular operator is approved or prohibited. The submission policy is implemented by the print shop management system software, which is stored in a storage (e.g., a hard disk drive) of a print shop management apparatus 1 and is executed by the print shop management apparatus 1 (e.g. a control computer), which is connected to the printers 2 and other devices of the print shop through a data communication line, such as an LAN (Local Area Network), as exemplary shown in FIG. 3.

Specifically, a submission policy in the print shop management system is defined as multiple, named settings of restriction criteria enforced at job submission time. Each policy setting is created by an administrator of the print shop management system. Each policy setting has a set of criteria. When an operator (user) requests to submit a job to a printer (referred to as “job submission time”), these criteria are used to judge whether the submission is prohibited or approved.

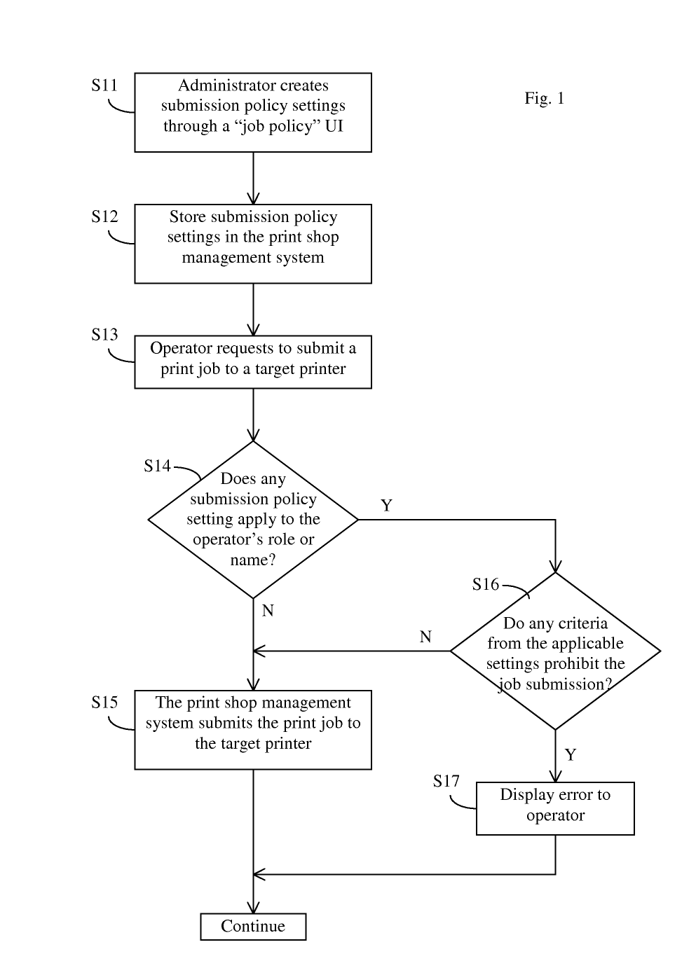

FIG. 1 illustrates a process of submission policy creation (steps S11-S12) and policy enforcement at submission time (steps S13-S17). As mentioned above, the process is implemented by a print shop management system software, which is stored in the storage of the print shop management apparatus 1 and is executed by a CPU (Central Processing Unit) of the print shop management apparatus 1. First, an administrator creates submission policy settings through an appropriate user interface of the print shop management system (step S11). The submission policy settings are stored in the storage of the print shop management apparatus 1 (step S12). Steps S11 and S12 may be performed at any time, and may be repeated to input additional policy settings as desired.

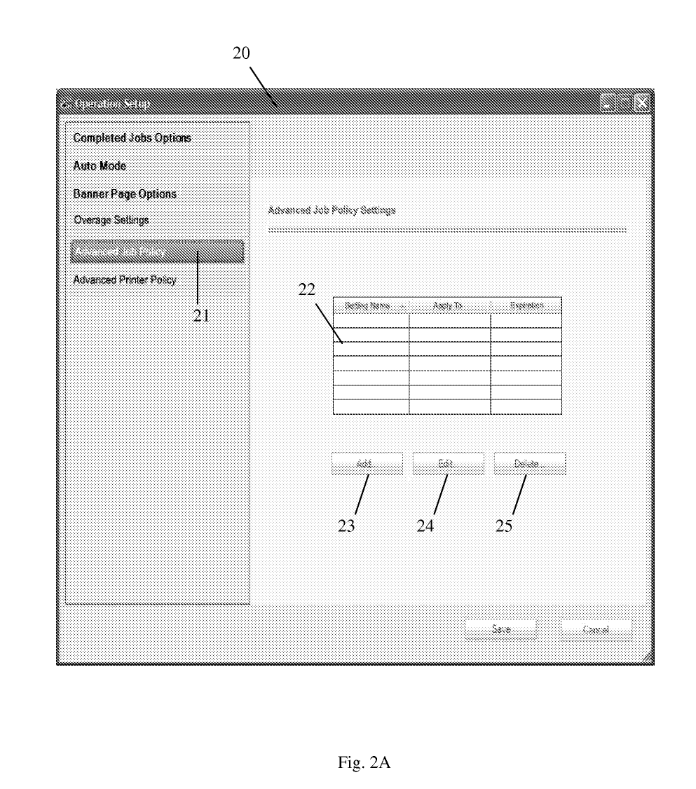

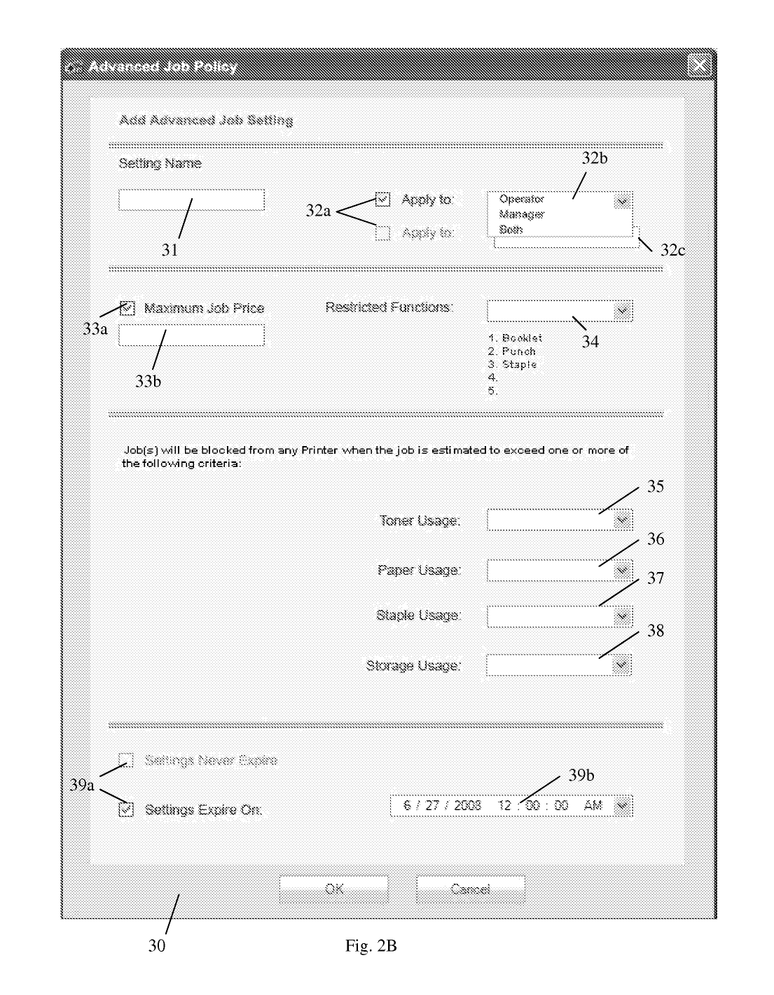

Referring to FIGS. 2A and 2B, an exemplary user interface which can be used in step S11 to create a submission policy is illustrated. FIG. 2A shows an “Operation Setup” dialog box 20 of the print shop management system software. An “Advanced Job Policy” button 21 is provided for viewing and creating a submission policy. Preferably, this button is displayed or selectable only when the user logs on as an administrator. When the button 21 is selected, a list of current job policy settings 22 is displayed. Each list item displays the name of the setting (“Setting Name”), the user role or user name that the setting applies to (“Apply To”), and an expiration date/time of the setting (“Expiration”). An Add button 23 is provided for adding a new policy setting, an Edit button 24 is provided for editing an existing policy setting (by selecting a desired setting in the list 22 first), and a Delete button 25 is provided for deleting an existing policy setting (by selecting a setting to be deleted in the list 22 first).

Upon selecting the “Add” or “Edit” button, an “Advanced Job Policy” dialog box 30 shown in FIG. 2B is opened to display a set of criteria selections. If it is an existing policy setting to be edited, the various input fields will be filled in with existing values; otherwise they will be initially blank or filled in with default values. The dialog box 30 includes an input field 31 to allow the administrator to specify or change the name of the policy setting. Policy setting values can be selected using the appropriate input features as described below.

“Apply to”: An input means is provided for the administrator to specify which users the current policy setting will be applicable to. For example, the policy may apply to a user according to his user role (a manager, a regular operator, a trainee, a combination of the above, etc.), according to his user name, according to the organizational unit he belongs to, etc. These descriptions regarding which users the policy setting will apply to are collectively referred to as the user criteria for convenience. A user to whom a policy setting will be applicable to is referred to as an “affected user” for convenience.

In the illustrated example, the input means include two check boxes 32a to specify whether the policy setting is applied according to a user role, or user name, or both. A drop-down list 32b is used to select the user role input value, and an input field 32c is used to input the user name. At submission time, the print shop management system will check the role and name of the submitting user; prohibition of submission is judged by comparing the job settings of the job being submitted against all criteria of all job policy settings that match the role or name of the submitting user.

“Maximum Job Price”: An input means is provided to set the maximum cost of any job that an affected user may print. In the illustrated example, the input means includes a check box 33a to select this criterion and an input field 33b to input a value. At submission time, the print shop management system will query an estimated cost of the job from the application that submitted the job. It will then compare the estimated job cost with the “Maximum Job Price” value for the policy setting. If the estimated cost of the job exceeds the “Maximum Job Price”, submission will be prohibited.

“Restricted Functions”: An input means is provided to specify one or more prohibited job settings (functions). In the illustrated example, the input means includes a drop-down list 34 that contains a list of functions to be selected from. A list of currently restricted functions may be displayed adjacent the drop-down list 34. An affected user is prohibited from submitting a job that contains these settings (functions). Examples of functions that may be prohibited include: booklet, punch, staple, perfect binding, job priority (high), save in user box, save in user box and print, front cover, back cover, paper inserter front cover, paper inserter back cover, trimming, folding, chapter, per page settings (page properties), density/brightness, smoothing, toner save (off), toner save (on), etc. At submission time, the print shop management system will compare the list of prohibited job settings against the settings found in the print job being submitted. If any identical settings are found, submission is prohibited.

“Toner Usage”, “Paper Usage”, “Staple Usage”, “Storage Usage”: Input means are provided to specify the maximum amounts of particular resources such as toner, paper, staple and storage (e.g. hard disk drive), etc. that the print job is permitted to consume. In the illustrated example, the input means includes a number of drop-down lists 35, 36, 37, 38 and further input fields (not shown). For each resource, the administrator can specify either a specific maximum amount of allowed consumption, or specify “Less than Target Device”, which means the maximum allowable amount is the amount of that resource available on the target device at submission time. At submission time, the amount of resources (toner, paper, staple, storage, etc.) that will be consumed by the job being submitted will be estimated based on the job settings (e.g. the number of pages in the document, whether it includes images which requires more toner, the number of copies to be printed, whether staple is requested, etc.). If the estimated amount of any resource exceeds the maximum value set for that resource, printing is prohibited. Using the “Less than Target Device” setting will prohibit a job submission if the job will completely consume a resource on the target printer so that a refill or other intervention would be required during printing.

Enforcement time period or expiration: An input means is provided to specify when the policy will be enforced or when it will expire. For example, the policy may be set to be enforced only during certain hours of the day (such as after normal business hours), or be set to expire after a particular time. In the illustrated example, the input means includes check boxes 39a to specify whether the setting will ever expire and an input field 39b to input the expiration time.

It should be noted while that FIGS. 2A and 2B show specific examples of policy setting criteria, other desirable criteria may be implemented. Further, although specific examples of input means 21-25 and 31-39b are described and shown, the invention is not limited to the specifics of the user interface displays. The invention may be implemented using any forms of user interface displays, as long as the user interface display includes input means that allows the user to specify various settings. The input means may be buttons, check boxes, radio buttons, text input fields, drop-down menus, pop-up menus, icons, tabs for bringing up different sheets, separate windows, etc., or combinations thereof, or any other suitable structure of allowing the user to input information to the computer. The computer software designs for suitable structures of the input means are apparent and familiar to a person of ordinary skill in this field. Therefore, detailed descriptions for these structures are omitted from here. The term “user interface display” is used to generally mean any suitable screen display that displays information to the user and/or allows the user to input commands and other information, and is not limited to any specific form of display, and may include a series of consecutive displays.

Referring back to FIG. 1, as mentioned earlier, steps S11 and S12 may be repeated as desired. The remaining steps of FIG. 1, steps S13 to S17, are executed at submission time. In implementation, steps S11-S12 and steps S13-S17 may be performed by different program modules.

At submission time, i.e., when a user requests to submit a print job to a printer (the “target printer”) (step S13), the print shop management system determines whether any submission policy settings apply to the user's role or user name (step S14). If no submission policy setting applies to the operator's role or name (“N” in step S14), the print shop management system proceeds to submit the print job to the target printer (step S15), and the process continues (the print shop management system is ready to process the next print job). If, on the other hand, one or more submission policy settings apply to the user's role or user name (“Y” in step S14), the system further determines whether any job restriction criteria from the applicable settings prohibit the job submission (step S16). These job restriction criteria may include maximum job price, restricted functions, resource usage (such as toner, paper, staple, storage usage, etc.), expiration (i.e. to determine whether the policy setting should be applied at the time of submission), etc. The values for these parameters for the print job are obtained by analyzing the settings of the print job. Examples of how the system applies the various job restriction criteria of a policy setting are described earlier in connection with FIGS. 2B. If the job submission is judged to be prohibited or not to be approved (“Y” in step S16), the job is not submitted and an error notification is displayed to the user (step S17). If the job submission is not prohibited or is approved (“N” in step S16), the print shop management system proceeds to submit the print job to the target printer (step S15), and the process continues.

As can be seen from the above descriptions, the policy setting method provides control of printer access which allows a print shop manager or owner to implement access control based on employee experience, appropriate date/time, device resources and status, cost of the print job, estimation of resources that will used by a job, etc. The policy has a “job submission scope,” meaning that the policy is enforced only during job submission. There is no affect on other areas of operation or workflow. The access control may be temporary or may be permanent by setting an expiration time.

Using the job submission approval policy according to embodiments of the present invention, the print shop manager/owner can decrease production mistakes (i.e. need to “redo” or “reprint” jobs) by employees that are inexperienced with a specific job setting. This saves time and cost of labor. The print shop manager/owner can decrease physical resource waste by employees that are inexperienced with specific job settings. They can control and/or decrease printer resource drainage from “resource intensive” jobs. They can prevent a job from completely draining a resource during printing (e.g. printing without toner or filling a hard disk). This may help to decrease hardware service calls (therefore decreasing cost) and increase operation “up time”. Each policy setting can be set on a temporary or permanent basis. They can create multiple policy settings (with specified names) for flexibility in identifying, creating, and editing multiple combinations of restriction criteria. This allows the manager/owner to address multiple job issues and purposes.

Further, although an error notification is displayed to the user when a print job submitted by the user interferes with any one of the various job restriction criteria of a policy setting, the print job may be subject to an inspection by an authorized person, e.g., the administrator, the manager, or the owner, and then the print job may be forwarded to the target printer once the authorized person approves the submission of the print job. In this regard, prohibition of the print job may include permanent prohibition and temporal prohibition.

It will be apparent to those skilled in the art that various modification and variations can be made in the print job submission approval policy creation and enforcement method of the present invention without departing from the spirit or scope of the invention. Thus, it is intended that the present invention cover modifications and variations that come within the scope of the appended claims and their equivalents.

What is claimed is:

1. A method for processing a print job submission implemented in a print shop management apparatus which manages a plurality of printers, comprising:
(a) storing a print job submission approval policy in the print shop management apparatus, the print job submission approval policy including a plurality of policy settings, each policy setting defining one or more job restriction criteria, each policy setting further defining one or more user criteria to specify which users the policy setting is applicable to;
(b) when a user requests to submit a print job to a printer, determining whether any policy setting is applicable to the user based on the user criteria for each policy setting;
(c) if one or more policy settings are applicable to the user, determining whether the submission is approved by comparing the job restriction criteria of the applicable policy settings with corresponding settings of the print job being submitted;
(d) if the submission is not approved, refraining from submitting the print job to the printer; and
(e) if no policy setting is applicable to the user or if the submission is approved, submitting the print job to the printer for printing.

2. The method of claim 1, wherein step (d) includes notifying a user of the non-approval.

3. The method of claim 1, wherein the user criteria include a user role or a user name or both.

4. The method of claim 1, wherein the job restriction criteria include one or more of a maximum job price, one or more restricted functions, and maximum resource usage for one or more resources.

5. The method of claim 4, wherein the resources include toner, paper, staple and storage.

6. The method of claim 4, wherein step (c) includes estimating amounts of resources required for the print job based on settings of the print job, and comparing the estimated amounts of resources required with the maximum resource usage specified in the policy setting.

7. The method of claim 4, wherein step (c) includes estimating amounts of resources required for the print job based on settings of the print job, and comparing the estimated amounts of resources required with amounts of the resources available on the printer at submission time.

8. The method of claim 1, wherein each policy setting includes an enforcement time period specifying when the policy setting is to be enforced.

9. The method of claim 1, further including, prior to step (a),
(f) entering one or more policy settings into the print shop management apparatus by an administrator.

10. A computer program product comprising a computer usable medium having a computer readable program code embedded therein for controlling a print shop management apparatus which manages a plurality of printers, the computer readable program code configured to cause the print shop management apparatus to execute a process for print job submission, the process comprising:
(a) storing a print job submission approval policy in the print shop management apparatus, the print job submission approval policy including a plurality of policy settings, each policy setting defining one or more job restriction criteria, each policy setting further defining one or more user criteria to specify which users the policy setting is applicable to;
(b) upon receiving a user request to submit a print job to a printer, determining whether any policy setting is applicable to the user based on the user criteria for each policy setting;
(c) if one or more policy settings are applicable to the user, determining whether the submission is approved by comparing the job restriction criteria of the applicable policy settings with corresponding settings of the print job being submitted;
(d) if the submission is not approved, refraining from submitting the print job to the printer; and
(e) if no policy setting is applicable to the user or if the submission is approved, submitting the print job to the printer for printing.

11. The computer program product of claim 10, wherein step (d) includes notifying a user of the non-approval.

12. A computer program product of claim 10, wherein the user criteria include a user role or a user name or both.

13. A computer program product of claim 10, wherein the job restriction criteria include one or more of a maximum job price, one or more restricted functions, and maximum resource usage for one or more resources.

14. A computer program product of claim 13, wherein the resources include toner, paper, staple and storage.

15. A computer program product of claim 13, wherein step (c) includes estimating amounts of resources required for the print job based on settings of the print job, and comparing the estimated amounts of resources required with the maximum resource usage specified in the policy setting.

16. A computer program product of claim 13, wherein step (c) includes estimating amounts of resources required for the print job based on settings of the print job, and comparing the estimated amounts of resources required with amounts of the resources available on the printer at submission time.

17. A computer program product of claim 10, wherein the job restriction criteria include an enforcement time period specifying when the policy is to be enforced.

18. A computer program product of claim 10, further including, prior to step (a),
(f) displaying a user interface for inputting policy setting values; and
(g) receiving inputs of policy setting values.

19. A method for processing a print job submission implemented in a print shop management apparatus which manages a plurality of printers, comprising:
(a) receiving a request to submit a print job to a printer;
(b) estimating an amount of a resource required for the print job based on settings of the print job;
(c) determining an amount of the resource available on the printer at submission time;
(d) if the required amount of the resource exceeds the available amount of the resource, refraining from submitting the print job to the printer; and
(e) if the required amount of the resource does not exceed the available amount of the resource, submitting the print job to the printer for printing.

20. The method of claim 19, wherein the resources include toner, paper, staple and storage.

21. The method of claim 19, wherein step (d) includes notifying a user of a non-approval.
